(19) United States
(12) Patent Application Publication
(10) Pub. No.: US 2026/0307555 A1
(43) Pub. Date: Oct. 8, 2026

(54) CHILD RESTRAINT

(71) Applicant: Shanghai Dorel Juvenile Company, Ltd., Shanghai (CN)

(72) Inventors: Shine FANG, Shanghai (CN); Jan HO, Shanghai (CN); Frank GUO, Shanghai (CN)

(21) Appl. No.: 19/639,813

(22) Filed: Apr. 6, 2026

(30) Foreign Application Priority Data
Apr. 7, 2025 (WO) PCT/CN2025/087415
Apr. 7, 2025 (WO) PCT/CN2025/087421
Apr. 7, 2025 (WO) PCT/CN2025/087485

(51) Int. Cl. B60N 2/28; B60N 2/90

(52) U.S. Cl. CPC B60N 2/2816; B60N 2/2818; B60N 2/2821; B60N 2/2857; B60N 2/2869; B60N 2/2875; B60N 2/919

(57) ABSTRACT

A child restraint includes a seat base and a juvenile seat. The juvenile seat is configured to pivot relative to the seat base between a travel orientation, including a forward-facing orientation and a rearward-facing orientation, and a sideways orientation for child ingress or egress. The juvenile seat is also configured to slide relative to the seat base when the juvenile seat is facing sideways to facilitate installation of a child in the juvenile seat.

### PRIORITY CLAIM

This application claims priority to International (PCT) Patent Application No. PCT/CN2025/087415, filed Apr. 7, 2025, International (PCT) Patent Application No. PCT/CN2025/087421, filed Apr. 7, 2025, and International (PCT) Patent Application No. PCT/CN2025/087485, filed Apr. 7, 2025, each of which is expressly incorporated by reference herein in its entirety.

### BACKGROUND

The present disclosure relates to a safety device, and particularly to a child seat. More particularly, the present disclosure relates to a child seat configured to be secured to a vehicle seat.

### SUMMARY

According to the present disclosure, a child restraint includes a seat base and a juvenile seat. The seat base is adapted to rest on a vehicle seat to secure the child restraint to the vehicle seat for transportation in a vehicle. The juvenile seat is formed to include a child-receiving space configured to hold a child for transportation in the vehicle.

In illustrative embodiments, the seat base includes a seat-base foundation and a belt retainer coupled to the seat-base foundation, and the child restraint further includes a belt-installation indicator coupled to the seat-base foundation. The seat-base foundation is formed to include a belt path configured to receive an attachment belt for securing the child restraint to a motor vehicle seat. The belt retainer is configured to move relative to the seat-base foundation from a clamped position clamping the attachment belt to the belt path and an opened position spaced apart from the belt path. The belt-installation indicator is configured to provide a first indication when the attachment belt is removed from the belt path and a second indication different than the first indication when the attachment belt is installed in the belt path and a predetermined load is applied on the belt path by the attachment belt.

In illustrative embodiments, the child restraint further includes a seat-orientation controller configured to control: (i) rotation of the juvenile seat relative to at least a portion of the seat base about a first axis between a rearward-facing orientation and a forward-facing orientation, and (ii) pivoting of the juvenile seat relative to at least a portion of the seat base from an upright orientation to a reclined orientation. The seat-orientation controller includes a rotation lock, a recline lock, and a lockout system. The rotation lock is configured to block movement of the juvenile seat relative to the seat base about the first axis from the rearward-facing orientation to the forward-facing orientation. The recline lock is configured to block movement of the juvenile seat relative to the seat base about the second axis between the upright orientation and the reclined orientation. The lockout system is moveable from an engaged configuration, in which the lockout system blocks movement of the juvenile seat relative to the seat base from the rearward-facing orientation to the forward-facing orientation when the juvenile seat is in the reclined orientation, to a disengaged configuration, when the juvenile seat is in the upright orientation so that the juvenile seat is free to rotate about the first axis from the rearward-facing orientation to the forward-facing orientation.

In illustrative embodiments, the seat-orientation controller further includes a rotating deck and a track. The rotating deck is coupled to the seat base for rotation with the juvenile seat about the vertical pivot axis. The track includes a first rail coupled to the rotating deck for rotation therewith and a second rail coupled to the juvenile seat to allow translation of the juvenile seat relative to the seat base along a sliding plane from a first position overlying the pivot axis and a second position at least partially offset from the pivot axis. The rotation lock is includes a release handle coupled to the juvenile seat and configured to be actuated by a user to change the rotation lock from the locked configuration to the unlocked configuration, a latch configured to engage the seat base in the locked configuration to block rotation of the juvenile seat relative to the seat base and located on a first side of the sliding plane, and an actuator coupled to the release handle and configured to release the latch from the seat base in the unlocked configuration. The actuator is located on a second side of the sliding plane opposite the first side and is configured to translate with the juvenile seat away from the latch.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a child restraint, in accordance with the present disclosure, including a seat base adapted to rest on an underlying vehicle seat, a juvenile seat coupled to the seat base and formed to include a child-receiving space configured to hold a child, and a seat-orientation controller configured to control pivotable movement of the juvenile seat relative to the seat base about a vertical axis from a travel orientation to an ingress-egress orientation, as shown in FIG. 2, and translation of the juvenile seat relative to the seat base to move the juvenile seat closer to an open door of a vehicle, as suggested in FIG. 3;

FIG. 2 is a perspective view of the child restraint showing the juvenile seat in the ingress-egress orientation;

FIG. 3 is a perspective view of the child restraint showing the juvenile seat translated relative to the seat base to expose a belt path so the child restraint can be attached to the vehicle seat using an attachment belt;

FIG. 4 is an exploded assembly view of the child restraint showing the juvenile seat separated from the seat base;

FIG. 5 is an enlarged view of a portion of the seat base showing the seat base including a seat-base foundation formed to include the belt path, a belt retainer coupled to the seat-base foundation to clamp the attachment belt to the seat-base foundation, and a belt-installation indicator coupled to the seat-base foundation and configured to indicate an installation status of the attachment belt;

FIG. 6 is a cross section taken along line 6-6 in FIG. 5 and perspective view of the seat base showing the belt retainer in an opened position and the attachment belt in a loose, uninstalled state and showing the belt-installation indicator displaying a first indication to indicate to a user that the attachment belt is not fully installed;

FIG. 7 is a cross section and perspective view of the seat base showing the belt retainer in a closed position and the attachment belt in a tight, installed state along the belt path and showing the belt-installation indicator displaying a second indication to indicate to a user that the attachment belt is fully installed;

FIG. 8 is an enlarged view of a portion of the seat base with a rear cover of the seat-base foundation removed to show the belt-installation indicator including (i) an indicator panel having the first indication and the second indication, (ii) a first panel actuator including a first pressure pad extending into the belt path and a first panel mover coupled between the first pressure pad and the indicator panel and biased toward an engaged position urging the indicator panel to a first position to display the first indication zone through a window formed in the seat shell, and (iii) a second panel actuator including a second pressure pad extending into the belt path and spaced apart from the first pressure pad and a second panel mover coupled between the second pressure pad and the indicator panel and biased to an engaged position urging the indicator panel to the first position to display the first indication zone through a window formed in the seat shell, and showing each of the actuators in a released position in which the indicator panel is free to move to a second position to display the second indication through the window;

FIG. 9 is a cross section taken along line 9-9 in FIG. 1 showing the seat-orientation controller including a rotation lock configured to block movement of the juvenile seat relative to the seat base about the vertical axis from a rearward-facing orientation to a forward-facing orientation, a recline lock configured to block movement of the juvenile seat relative to the seat base about a second axis between an upright orientation and a reclined orientation, and a lockout system moveable from an engaged configuration, in which the lockout system blocks movement of the juvenile seat relative to the seat base from the rearward-facing orientation to the forward-facing orientation when the juvenile seat is in the reclined orientation, to a disengaged configuration, when the juvenile seat is in the upright orientation so that the juvenile seat is free to rotate about the first axis from the rearward-facing orientation to the forward-facing orientation;

FIG. 10 is an enlarged portion of the child restraint shown in FIG. 9 showing the lockout system including a stop coupled to the seat base, a cam coupled to the juvenile seat, and a circumferential-motion blocker having a first travel path about the first axis and offset from the stop when the juvenile seat is in the upright orientation and a second travel path about the first axis and aligned with the stop when the juvenile seat is in the reclined orientation to block the juvenile seat from rotating to the forward-facing orientation until the juvenile seat is in the upright orientation;

FIG. 11 is a top view of the child restraint with the juvenile seat and portions of the seat-orientation controller removed to show the lockout system in the forward-facing orientation;

FIG. 12 is a top view of the child restraint with the juvenile seat and portions of the seat-orientation controller removed to show the lockout system in the sideways orientation and showing the circumferential-motion blocker having the second travel path to engage with the stop;

FIG. 13 is an enlarged view of a portion of FIG. 9 showing portions of the rotation lock including a latch and an actuator configured to move the latch from a locked position blocking rotation of the juvenile seat about the vertical axis to an unlocked position freeing the juvenile seat for rotation about the vertical axis; and

FIG. 14 is an enlarged view similar to FIG. 13 showing the actuator in an actuated position and the latch in the unlocked position.

### DETAILED DESCRIPTION

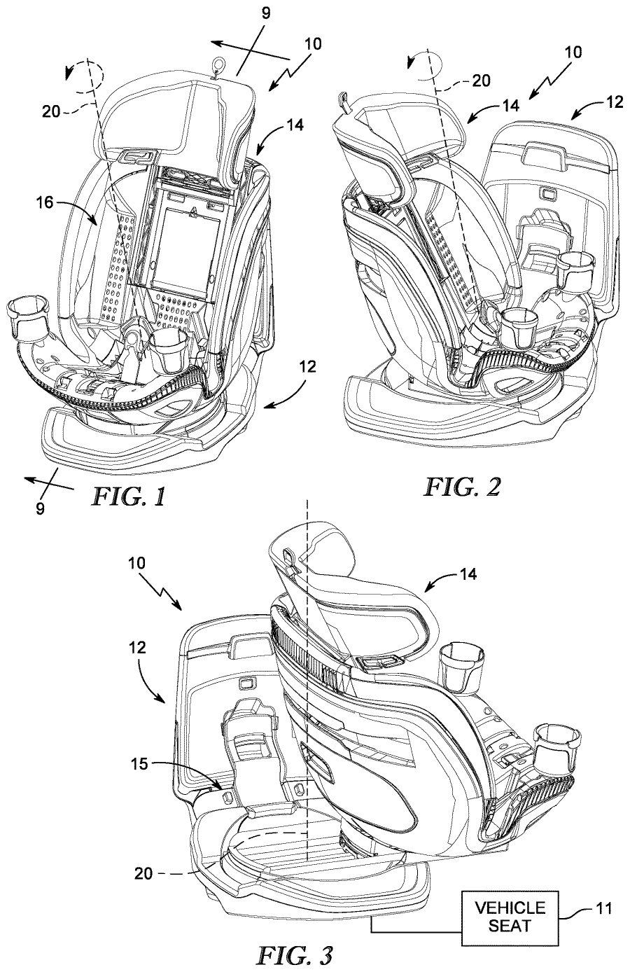

A child restraint 10 includes a seat base 12 and a juvenile seat 14 as shown in FIGS. 1-3. The seat base 12 is adapted to rest on and secure to a vehicle seat 11 for transportation in a vehicle. The juvenile seat 14 is coupled to the seat base 12 and is formed to include a child-receiving space 16 adapted to hold a child for transportation in the vehicle.

The juvenile seat 14 is movable relative to the seat base 12 to adjust a mode of operation of the child restraint 10 as shown in FIGS. 1-3. In illustrative embodiments, the child restraint 10 further includes a seat-orientation controller 18 configured to control movement of the juvenile seat 14, or at least a portion thereof, relative to the seat base 12, or a portion thereof. Specifically, the seat-orientation controller 18 is configured to control rotation of the juvenile seat 14 relative to at least a portion of the seat base 12 about a first axis 20 between a travel orientation, including a forward-facing orientation and a rearward-facing orientation, and an ingress-egress orientation, including a first sideways orientation about 90 degrees from the forward-facing orientation and the rearward-facing orientation about the first axis and a second sideways orientation about 180 degrees from the first sideways orientation about the first axis. The seat-orientation controller 18 is also configured to control pivoting of the juvenile seat 14 relative to at least a portion of the seat base 12 about a second axis 22, orthogonal to the first axis 20, from an upright orientation to one or more reclined orientations.

The seat base 12 is formed to include the belt path 15 configured to receive an attachment belt 17 for securing the child restraint 10 to a motor vehicle seat 11. The attachment belt 17 may be a vehicle seat belt or a separate belt from the motor vehicle. To secure the child restraint 10, the attachment belt 17 is routed across the belt path 15, secured (i.e. to latch points or a buckle included in the motor vehicle seat), and tightened to apply pressure on the belt path 15 and restrict movement of the child restraint 10 relative to the motor vehicle seat 11. In some embodiments, the seat base 12 and the juvenile seat 14 are unitary to provide, collectively, a seat shell that is formed to include the belt path 15. Further, in some embodiments, the seat base may be omitted, or the juvenile seat 14 may be coupled to the vehicle seat without the seat base 12 in the case of an infant carrier, for example.

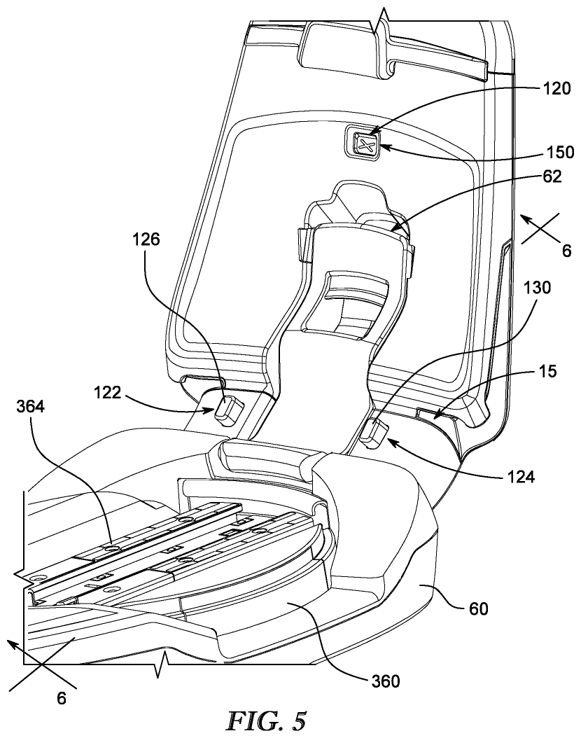

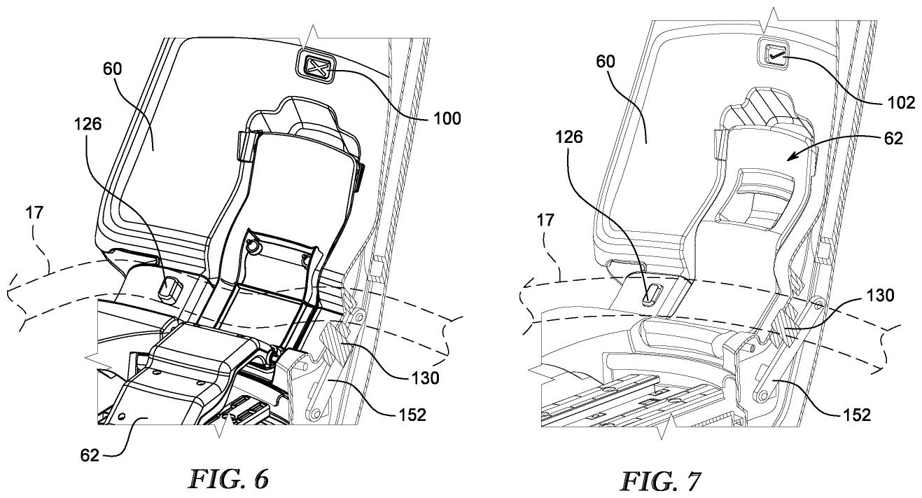

The seat base 12 includes a seat-base foundation 60 and a belt retainer 62 coupled to the seat-base foundation as shown in FIGS. 5-7. The seat-base foundation 60 is formed to include the belt path 15. The belt retainer 62 is coupled to the seat-base foundation 60 for pivotable movement relative to the seat-base foundation 60 between an opened position, as shown in FIG. 6, and a closed, clamped position as shown in FIG. 7. In the opened position, the belt path 15 is open to receive the attachment belt 17. In the clamped position, the belt retainer 62 is locked on top of the attachment belt 17 to retain the attachment belt in place. In some embodiments, the juvenile seat 14 is configured to translate relative to the seat base from the sideways position overlying the pivot axis 20 to a belt-installation position offset from the pivot axis 20 where the belt path 15 is exposed, as shown in FIG. 3, and the belt retainer 62 is free to pivot to the opened position for installation of the attachment belt 17.

In illustrative embodiments, the child restraint 10 further includes a belt-installation indicator 19 configured to indicate when the attachment belt 17 has been installed properly. In other words, the belt installation indicator 19 is configured to provide one or more indications when pressure exerted by the attachment belt 17 on the belt path 15 is at or above a predetermined amount and/or is routed completely across the belt path 15 without being misaligned with the belt path 15.

The belt-installation indicator 19 is configured to provide a first indication or a second indication (or additional indications) depending on a state of the attachment belt 17 relative to the belt path 15. The first indication is displayed when the attachment belt 17 is not installed properly. For example, the first indication may be displayed when the attachment belt 17 is all or partially removed from the belt path 15 and/or when pressure exerted on the belt path 15 by the attachment belt 17 is below the predetermined amount, and/or when the attachment belt 17 is misaligned with the belt path 15. The second indication is different than the first indication and is displayed when the attachment belt 17 is routed all the way across the belt path 15 and exerts a pressure on the belt path 15 at or above the predetermined amount. The first and second indications include visual indications (i.e. colors, icons, text, etc.) in the illustrative embodiment, but one or more other indications, such as an audible indication or a tactile indication, can also be used.

The belt-installation indicator 19 includes an indicator panel 120, a first panel actuator 122, and a second panel actuator 124 spaced apart from and movable separately from the first panel actuator 122. The indicator panel 120 includes a first indication zone 100 configured to display the first indication and a second indication zone 102 configured to display the second indication.

The first panel actuator 122 includes a first pressure pad 126 extending into the belt path 15 and a first panel mover 128 coupled between the first pressure pad 126 and the indicator panel 120. The second panel actuator 124 includes a second pressure pad 130 extending into the belt path 15 and spaced apart from the first pressure pad 126 and a second panel mover 132 coupled between the second pressure pad 130 and the indicator panel 120.

The first and second panel movers 128, 132 are biased (i.e. by respective springs 136, 138) to an engaged position urging the indicator panel 120 to a first position to display the first indication zone 100 through a window 150 formed in the seat base 12. The indicator panel 120 is biased (i.e. by a spring 140) toward a second position in which the second indication zone 102 is displayed through the window 150. The indicator panel 120 is movable to the second position only when pressure at or above the predetermined amount is applied to both the first pressure pad 126 and the second pressure pad 130 to cause both the first and second panel movers 128, 132 to move to a released position where the indicator panel 120 is freed to move to the second position.

In the illustrative embodiment, each of the panel movers 128, 132 includes a cable 142, 144 coupled to each respective pressure pad 126, 130 and a lever 146, 148 coupled to the indicator panel 120. Actuating the pressure pads 126, 130 causes each respective cable 142, 144 to be pulled and overcomes the springs 136, 138. In turn, the cables 142, 144 pull the levers 146, 148 to disengage from the indicator panel 120. With the levers 146, 148 disengaged, the spring 140 connected to the indicator panel 120 pulls the indicator panel 120 from the first position to the second position where the second indication zone 102 is displayed through the window 150.

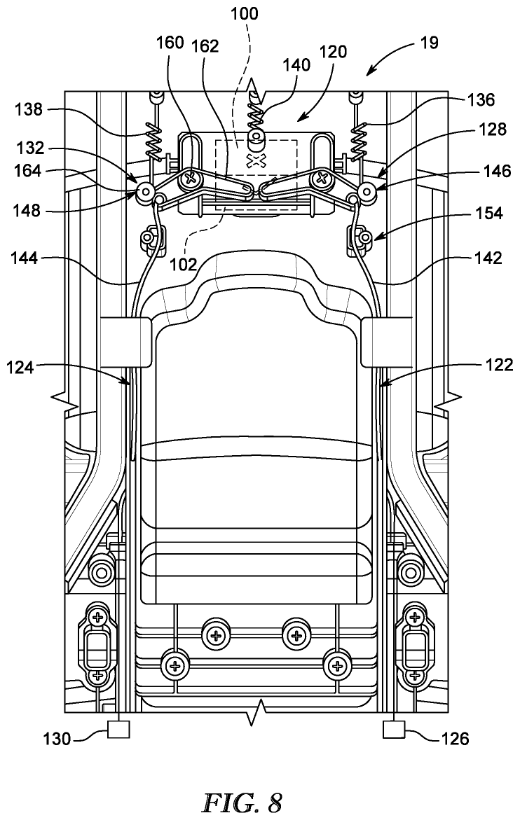

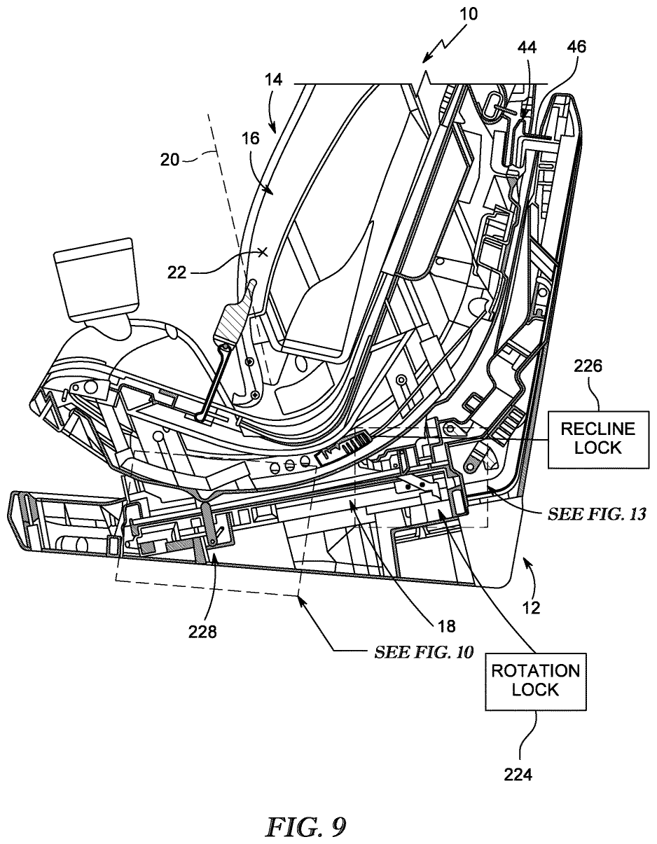

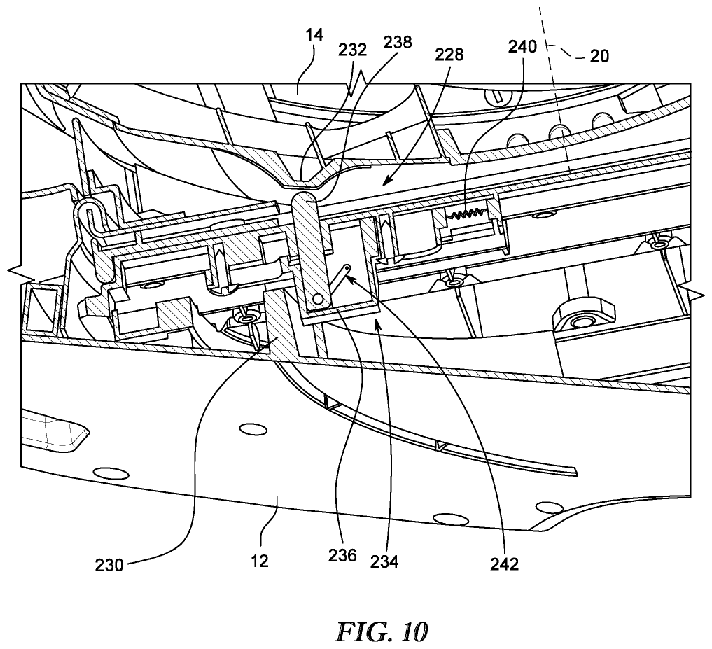

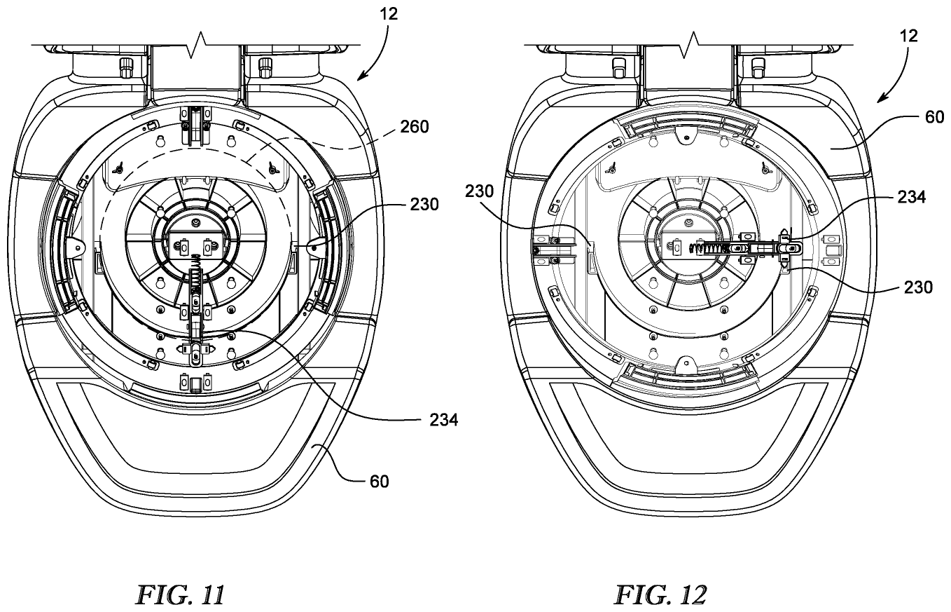

Each of the levers 146, 148 includes a pivot axle 160, a push arm 162, and a cable mount 164 as shown in FIG. 8. The pivot axle 160 is fixed to the seat base foundation to establish an axle pivot axis for each respective lever 146, 148. The push arm 162 is configured to engage the indicator panel 120. The cable mount 164 is coupled directly with the cable 142,144 and is located on an opposite side of the pivot axle 160 from the push arm 162. Springs are also coupled to the cable mount 164 to bias each lever 146, 148 for rotation about the axle pivot axis so that the push arms 162 are normally urged into contact with the indicator panel 120.

In the illustrative embodiment, the belt-installation indicator 19 further includes intermediate levers 152 (only one of which is shown) each coupled to a respective pressure pad 126, 130 and a respective cable 142, 144. The intermediate levers 152 are pivoted by the pressure pads 126, 130 and pull the cables 142, 144. The cables 142, 144 may be routed through one or more pulleys 154 to orient the pulling force in a direction that causes sliding movement of the indicator panel 120 from the first position to the second position. The levers 152 orient the cables 142, 144, which are flexible in the illustrative embodiment, in a position that minimizes obstruction with other portions of the seat base 12. In some embodiments, the cables 142, 144 can be coupled directly to the pressure pads 126, 130, respectively.

The seat-orientation controller 18 includes a rotation lock 224, a recline lock 226, and a forward-facing lockout system 228. The rotation lock 224 is configured to block movement of the juvenile seat 14 relative to the seat base 12 about the first axis 20 from the travel orientation to the ingress-egress orientation. The recline lock 226 is configured to block movement of the juvenile seat 14 relative to the seat base 12 about the second axis 22 between the upright orientation and the reclined orientation(s). The forward-facing lockout system 228 is moved when the juvenile seat adjusts between the upright orientation and the reclined orientation(s).

In the illustrative embodiment, the forward-facing lockout system 228 is moveable from an engaged configuration to a disengaged configuration. In the engaged configuration, the forward-facing lockout system 228 blocks movement of the juvenile seat 14 relative to the seat base 12 from the ingress-egress orientation to the travel orientation when the juvenile seat 14 is in the reclined orientation. In the disengaged configuration, the juvenile seat 14 is free to rotate about the first axis 20 from the ingress-egress orientation to the travel orientation when the juvenile seat 14 is in the upright orientation.

The forward-facing lockout system 228 includes a stop 230 coupled to the seat base 12, a cam 232 coupled to the juvenile seat 14, and a circumferential-motion blocker 234 coupled to the juvenile seat 14. The stop 230 is coupled to the seat base 12 in a fixed position and remains in the fixed position as the juvenile seat 14 rotates and reclines. The cam 232 is coupled to the juvenile seat 14 and is moveable with the juvenile seat about the first axis 20 and the second axis 22. The circumferential-motion blocker 234 is movable with the juvenile seat 14 about the first axis 20 and is movable relative to the juvenile seat 14 as the juvenile seat 14 changes between the upright orientation and the reclined orientation.

The circumferential motion blocker 234 includes a blocker body 236, a body actuator 238, and a bias member 240. The blocker body 236 is moveable relative to the juvenile seat 14 between a disengaged position withdrawn from an interference path 260 with the stop 230 and an engaged position extending into the interference path 260 with the stop 230 to engage the stop 230 and block rotation of the juvenile seat 14 about the first axis 20 to the forward-facing orientation. The body actuator 238 is coupled to the blocker body 236 and extends toward the cam 232. The body actuator 238 is separated from the cam 232 in the reclined orientation and is configured to engage the cam 232 in the upright orientation to cause movement of the blocker body 236 from the disengaged position to the engaged position. The bias member 240 is configured to bias the blocker body 236 toward the engaged position so that the blocker body 236 normally and automatically assumes the engaged position when the juvenile seat 14 is in the reclined orientation and not in the upright orientation.

The blocker body 236 is formed to include an angled slot 242. The body actuator 238 is received in the slot 242 so that movement of the body actuator 238 in a first direction causes movement of the blocker body 236 in a second direction different than the first direction as the blocker actuator 238 travels through the slot 242.

In some embodiments, the lockout system 228 may be configured to block movement of the juvenile seat 14 relative to the seat base 12 from the forward-facing orientation to the rearward-facing orientation, from the forward-facing orientation to the ingress-egress orientation, and/or from the ingress-egress orientation to the rearward-facing orientation if the juvenile seat 14 is in the upright orientation or the reclined orientation. For example, in some embodiments, the lockout system 228 may be configured to block rotation of the juvenile seat 12 about the first axis 20 from the forward-facing orientation to the rearward-facing orientation until the juvenile seat 14 is moved from the upright orientation to the reclined orientation.

In illustrative embodiments, the seat orientation controller 18 also allows the juvenile seat 14 to slide or translate relative to the seat base 12 when the juvenile seat 14 is in the sideways orientation between a first position overlying the seat base 12 and a second position at least partially offset from the seat base 12 toward a door of the vehicle. In other words, the seat orientation controller 18 allows the juvenile seat 14 to be pulled by a user toward an open door of the vehicle and away from the seat base 12 for easier child ingress/egress. The cam 232 is coupled to the juvenile seat 14 or a portion of the seat-orientation controller 18 that translates with the juvenile seat 14 while the stop 230 and the circumferential motion blocker 234 are coupled to the seat base 12 or a portion of the seat orientation controller 18 that remains in place with the seat base 12 when the juvenile seat 14 translates away from the seat base 12 to the second position. In this way, the cam 232 is separated from the circumferential motion blocker 234 when the juvenile seat 14 is in the second position and the circumferential motion blocker 234 may block rotation of the juvenile seat 14 about the axis 20. Thus, the circumferential motion blocker 234 may block rotation of the juvenile seat 14 when the juvenile seat 14 is in the upright orientation and in the second position, and the circumferential motion blocker 234 disengages the stop 230 when the juvenile seat 14 is returned to the first position while the juvenile seat 14 is still in the upright orientation so that the juvenile seat 14 is free to return to the forward-facing orientation and/or the rearward-facing orientation.

The seat base 12 may be shaped to form a recessed area 322 and one or more locking position pockets 324. The recessed area 322 is shaped to receive the juvenile seat 14. The rotation lock 224 is configured to extend into the locking position pockets 324 to lock the juvenile seat 14 in position with respect to the seat base 12.

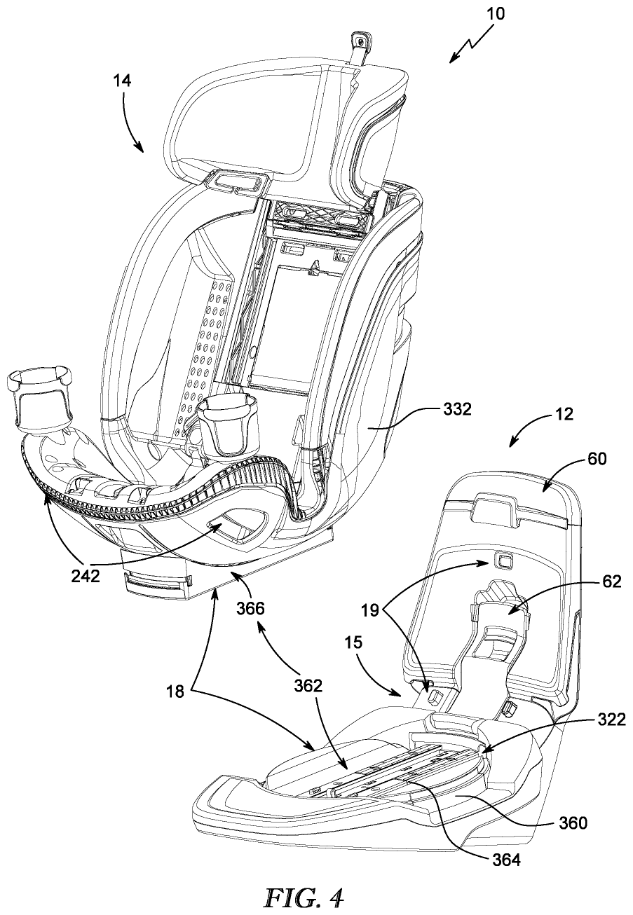

The juvenile seat 14 includes a seat shell 332 forming an outer surface of the juvenile seat 14. As shown in FIG. 4, the rotation lock 224 includes two release handles 342 formed on the underside of the seat shell 332, a latch or locking pin 352 configured to engage selectively with the seat base 12 to block rotation of the juvenile seat 14, and an actuator 343 extending between and connecting the release handles 342 and the latch 352.

The actuator 343 includes cables 346 coupled to the release handles 342, a sliding lock member or cam block 344 shaped to form an angled slot 345, a pin 348 extending through the angled slot 345, and a sliding post or actuator post 350 coupled to the pin 348. Each respective release handle 342 is positioned on a corresponding one of the right and left side of the juvenile seat 14 to allow a user to easily access the release handles 342. Pulling one of the release handles 342 actuates the actuator 343 and unlocks latch 352 from the seat base 12 to allow a caregiver to rotate the juvenile seat 14 relative to the seat base 12. The cables 346 are connected to the release handles 342 and are routed through one or more cavities formed in the seat shell 332 to the sliding lock member 344. As one or both of the release handles 342 are pulled by a user, the cable 346 is pulled through the seat shell 332 in the movement direction of the handle 342, pulling the sliding lock member 344 relative to the seat base 12.

The cam block 344 is shaped to form the angled slot 345, which is angled in a direction towards the seat base 12 to cause the latch 343 to unlock when one of the release handles 342 are actuated. The pin 348 extends through the slot 345 and is coupled to the actuator post 350. As the cam block 344 translates due to the force applied by the user via the cables 346, the angled direction of the slot 345 directs the pin 348 to slide downward within the slot 345. The downward motion of the pin 348 exerts a force on the actuator post 350, which cause the sliding post 350 to actuate the spring loaded latch 352.

The latch 352 is biased to extend into one of the locking position pockets 324 formed in the seat base 12. There is a locking position pocket 324 that corresponds to each of the forward-facing and rearward-facing orientations of the juvenile seat 14 to lock the position of the juvenile seat 14 relative to the seat base 12 in each of the positions. In some embodiments, pockets may also be included to lock the juvenile seat 14 in the sideways positions as well. When the juvenile seat 14 is in the forward facing position, the latch 352 engages a first of two locking position pockets 324 to lock the juvenile seat 14 in the forward-facing orientation. When the juvenile seat 14 is in the rearward-facing orientation, the latch 352 engages a second of the two locking position pockets 324.

When the actuator post 350 is pushed downwards to actuate the latch 352, the latch 352 is moved out of either the forward facing or rear facing locking position pocket 324 formed in the seat base 12 to allow the juvenile seat 14 to rotate between positions relative to the seat base 12. Once the latch 352 is actuated, the juvenile seat 14 is unlocked with respect to the seat base 12 and free to rotate between positions. A user can then rotate the juvenile seat 14 either clockwise or counterclockwise with respect to the seat base 12. This allows a user to move the seat into one of the four positions.

When the juvenile seat 14 is in the left side facing or right side facing positions, a user can rotate the juvenile seat 14 into the forward facing or rearward facing position to lock the juvenile seat 14 in place with respect to the seat base 12. To rotate the juvenile seat 14 from the forward-facing or rearward-facing orientation, a user pulls one of the two release handles 342 on the bottom of the seat shell 332 to allow the juvenile seat 14 to rotate with respect to the seat base 12.

In the illustrative embodiment, the juvenile seat 14 does not lock in the left or right sideways positions about the vertical axis 20. This is because the juvenile seat 14 is also slidable relative to the seat base 12 when the juvenile seat 14 is in the left and right sideways positions. The actuator post 350 and the latch 352 are separate components and are separated from one another along a sliding plane 400 of the juvenile seat 14 relative to the seat base 12 when the actuator post 350 is raised. This separation allows the actuator post 350 to slide with the juvenile seat 14 and away from the latch 352 when the juvenile seat 14 is slid outward away from the seat base 12 for easier installation of a child in the juvenile seat 14.

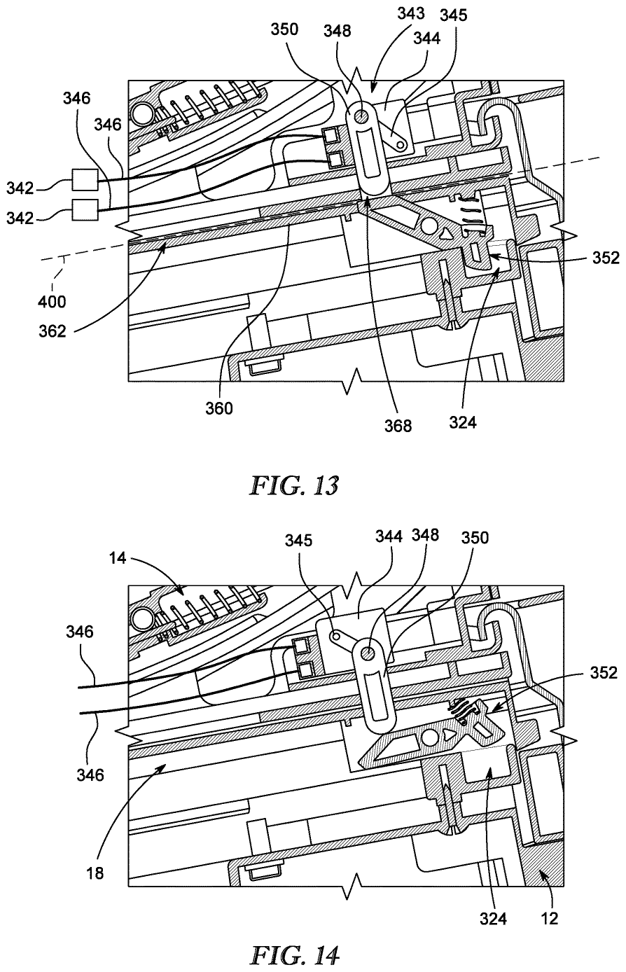

In some embodiments, the seat-orientation controller 18 further includes a rotating deck 360 and a track 362 as shown in FIGS. 4, 13, and 14. The rotating deck 360 is coupled to the seat base 12 for rotation with the juvenile seat 14 about the pivot axis 20. The track 362 includes a first rail 364 coupled to the rotating deck 360 for rotation therewith and a second rail 366 coupled to the juvenile seat 14. The first and second rails 364, 366 are configured to allow translation of the juvenile seat 14 relative to the seat base 12 along the sliding plane 400 from a first position overlying the pivot axis 20 and a second position at least partially offset from the pivot axis 20 as suggested in FIGS. 2 and 3. The latch 352 is located on a first side (i.e. lower side) of the sliding plane 400. The actuator 343 is located on a second side (i.e. upper side) of the sliding plane 400 opposite the first side and is configured to translate with the juvenile seat 14 away from the latch 352. The actuator post 350 is also configured to extend into an opening 368 formed in the track 362 to block translation of the juvenile seat 14 while one of the handles 342 are actuated and a user is rotating the juvenile seat 14 about the axis 20. Once the release handle 342 is released, the actuator post 350 returns to an unactuated position so the juvenile seat 14 is free to translate relative to the seat base 12.

In some embodiments, a vehicle belt tension indicator feature is used in connection with a rotational child car seat. The vehicle belt tension indicator may be used on a child car seat base to indicate whether the vehicle seat belt is properly tightened to secure the seat base to the motor vehicle seat. The vehicle seat belt may be used to secure the child seat in the vehicle. The vehicle seat base is formed to include a pathway or channel and the vehicle seat belt passes through the channel. The channel (belt path area) includes two buttons that are pushed downward as the vehicle seat belt is tightened by a user.

In some embodiments, as a vehicle belt applies a downward force on each button, each button rotates a swing arm about a pivot point. The upper end of the swing arm is coupled to a cable that is routed up a back of the seat base. Each cable is connected to a rotating paddle or lever that, when rotated, move a color or indicator panel on the reverse side from red to green to indicate that proper tension is being applied to the vehicle seat belt.

In some embodiments, as the indicator panel moves from one position to another, the front face of the indicator panel translates across a viewing window in the base. This will allow the user to see one of two colors applied to the front face of the indicator panel. When the color has fully transitioned from one color to the other, the user knows sufficient tension exists in the belt path.

In some embodiments, both buttons/cables/paddles on both sides are pulled together for the color window to change from red to green. If both buttons do not have proper tension then the color window may not change to green as one of the levers will hold the indicator panel in the first position. This alerts the user that the vehicle seat belt was not properly installed when securing the child seat base to the vehicle.

In some embodiments, the child restraint includes a forward-facing recline lockout system. The forward-facing recline lockout system may be used on a rotating child car seat, where the child seat rotates about a vertical axis with respect to the base. This allows a parent to rotate the seat toward the door of a motor vehicle so that it is easier to place or remove a child from the car seat or to position the child in a forward or rearward orientation within the vehicle. The proposed lockout system may block the child seat from being rotated to a forward facing position unless the child seat is returned to its full upright position and is not in a reclined position.

In some embodiments, the child and seat are configured to be in an upright position when the child seat is rotated to the forward facing position for safety purposes. In the rearward orientation, the seat can be reclined. To block the improper position of the child seat in the forward facing position the lockout system may block the seat from being fully rotated to the forward position unless the seat is in its full upright position. To fully secure the seat to the base in the forward position, a groove 44 formed in the seat shell may need to align with a post or seat anchor 46 formed in the seat base to lock the two together. The forward facing lockout system may only allow for one forward facing recline position. Because this retention system slides into place from the side as the seat rotates into forward facing position, the a lock out system blocks rotation to the forward facing orientation when in other recline positions. The lockout system can also be used to block rotation of the juvenile seat relative to the seat base for other reasons.

In some embodiments, when the shell is in the proper forward facing recline upright position, a cam system on the bottom of the seat shell is moved into a position and depresses a post located within the base of the seat. When this post is depressed by the cam, it pushes down on a pin mounted through it and an angled slot cut into the sliding lockout. The pin, through the use of the slot, pushes the sliding lockout back, against the biasing force of the spring.

In some embodiments, with this lockout moved into the open position, there is no interference with a large semicircular rib built into the base. When the shell is moved to another recline position, the cam no longer depresses the pin, and the spring pushes the blue slide back into the lockout position. In this position, when the shell is out of the forward facing orientation, the slide will interfere with the semicircular rib to block rotation back into the forward facing orientation.

The following numbered clauses include embodiments that are contemplated and non-limiting:

Clause 1. A child restraint includes a seat base adapted to rest on and secure to a vehicle seat for transportation in a vehicle.

Clause 2. The child restraint of clause 1, any other suitable clause or any suitable combination of clauses, including a juvenile seat coupled to the seat base and formed to include a child-receiving space adapted to hold a child for transportation in the vehicle.

Clause 3. The child restraint of clause 2, any other suitable clause or any suitable combination of clauses, including a seat-orientation controller configured to control rotation of the juvenile seat relative to at least a portion of the seat base about a first axis between a forward-facing orientation and a rearward-facing orientation.

Clause 4. The child restraint of clause 3, any other suitable clause or any suitable combination of clauses, The seat-orientation controller configured to control pivoting of the juvenile seat relative to at least a portion of the seat base about a second axis, orthogonal to the first axis, from an upright orientation to a reclined orientation.

Clause 5. The child restraint of clause 4, any other suitable clause or any suitable combination of clauses, wherein the seat-orientation controller includes a rotation lock configured to block movement of the juvenile seat relative to the seat base about the first axis between the forward-facing orientation and the rearward-facing orientation.

Clause 6. The child restraint of clause 5, any other suitable clause or any suitable combination of clauses, including a recline lock configured to block movement of the juvenile seat relative to the seat base about the second axis between the upright orientation and the reclined orientation.

Clause 7. The child restraint of clause 6, any other suitable clause or any suitable combination of clauses, including a forward-facing lockout system moveable from an engaged configuration, in which the forward-facing lockout system blocks movement of the juvenile seat relative to the seat base from the rearward-facing orientation to the forward-facing orientation when the juvenile seat is in the reclined orientation, to a disengaged configuration, when the juvenile seat is in the upright orientation so that the juvenile seat is free to rotate about the first axis from the rearward-facing orientation to the forward-facing orientation.

1. A child restraint comprising:
a seat base including a seat-base foundation formed to include a belt path configured to receive an attachment belt for securing the child restraint to a motor vehicle seat and a belt retainer coupled to the seat-base foundation for movement relative to the seat-base foundation from a clamped position clamping the attachment belt to the belt path and an opened position spaced apart from the belt path,
a juvenile seat coupled to the seat base for movement relative to the seat base from a travel orientation including a forward-facing orientation and a rearward-facing orientation to a base-installation position at least partially offset from the seat base to expose the belt path to receive the attachment belt, and provide clearance for the belt retainer to move to the opened position, and
a belt-installation indicator coupled to the seat base configured to provide a first indication when the attachment belt is removed from the belt path and a second indication different than the first indication when the attachment belt is installed in the belt path and a predetermined load is applied on the belt path by the attachment belt,
wherein the belt-installation indicator includes: (i) an indicator panel having a first indication zone and a second indication zone, (ii) a first panel actuator including a first pressure pad extending into the belt path and a first panel mover coupled between the first pressure pad and the indicator panel and biased toward an engaged position urging the indicator panel to a first position to display the first indication zone through a window formed in the seat shell, and (iii) a second panel actuator including a second pressure pad extending into the belt path and spaced apart from the first pressure pad and a second panel mover coupled between the second pressure pad and the indicator panel and biased to an engaged position urging the indicator panel to the first position to display the first indication zone through a window formed in the seat shell.

2. The child restraint of claim 1, wherein the indicator panel is biased toward a second position in which the second indication zone is displayed through the window and the indicator panel is movable to the second position only when the predetermined load is applied to both the first pressure pad and the second pressure pad to cause both the first and second panel movers to move to a released position where the indicator panel is freed for movement to the second position.

3. The child restraint of claim 1, wherein the first panel mover and the second panel mover each include a cable coupled to each respective pressure pad and a lever biased into engagement with the indicator panel to urge the indicator panel toward the first position.

4. The child restraint of claim 3, wherein each of the levers includes a pivot axle fixed to the seat base foundation to establish a pivot axis for each respective lever, a push arm configured to engage the indicator panel, a cable mount coupled directly with the cable and located on an opposite side of the pivot axle from the push arm.

5. The child restraint of claim 3, wherein each lever is biased toward the engaged position by a first spring configured to provide a first force on the indicator panel and the indicator panel is biased toward to second position by a second spring configured to provide a second force on the indicator panel less than the first force.

6. The child restraint of claim 3, wherein the first panel mover and the second panel mover each further include an intermediate lever coupled directly to each respective pressure pad for movement therewith and directly to each respective cable.

7. A child restraint comprising
a seat base adapted to rest on and secure to a vehicle seat for transportation in a vehicle,
a juvenile seat coupled to the seat base and formed to include a child-receiving space adapted to hold a child for transportation in the vehicle, and
a seat-orientation controller configured to control: (i) rotation of the juvenile seat relative to at least a portion of the seat base about a first axis between a rearward-facing orientation and a forward-facing orientation, and (ii) pivoting of the juvenile seat relative to at least a portion of the seat base from an upright orientation to a reclined orientation,
wherein the seat-orientation controller includes a rotation lock configured to block movement of the juvenile seat relative to the seat base about the first axis from the rearward-facing orientation to the forward-facing orientation, a recline lock configured to block movement of the juvenile seat relative to the seat base about the second axis between the upright orientation and the reclined orientation, and a lockout system moveable from an engaged configuration, in which the lockout system blocks movement of the juvenile seat relative to the seat base from the rearward-facing orientation to the forward-facing orientation when the juvenile seat is in the reclined orientation, to a disengaged configuration, when the juvenile seat is in the upright orientation so that the juvenile seat is free to rotate about the first axis from the rearward-facing orientation to the forward-facing orientation.

8. The child restraint of claim 7, wherein the lockout system includes a stop coupled to the seat base, a cam coupled to the juvenile seat, and a circumferential-motion blocker having a first travel path about the first axis and offset from the stop when the juvenile seat is in the upright orientation and a second travel path about the first axis and aligned with the stop when the juvenile seat is in the reclined orientation.

9. The child restraint of claim 8, wherein the circumferential-motion blocker includes a blocker body movable between the first travel path and the second travel path, a body actuator coupled to the locker body and configured to engage the stop when the juvenile seat is in the upright orientation, and a bias member configured to urge the blocker body toward the second travel path.

10. The child restraint of claim 9, wherein the blocker body is formed to include an angled slot and the body actuator is received in the slot so that movement of the body actuator in a first direction causes movement of the blocker body in a second direction different than the first direction as the blocker actuator travels through the slot.

11. The child restraint of claim 8, wherein the juvenile seat is movable to a sideways-facing orientation and is configured to translate relative to the seat base from a first position overlying the first pivot axis to a second position at least partially offset from the first pivot axis.

12. The child restraint of claim 11, wherein the cam translates with the juvenile seat to the second position to separate from the circumferential-motion blocker so that the circumferential-motion blocker assumes the second travel path to block rotation of the juvenile seat about the first axis while the juvenile seat is in the second position.

13. The child restraint of claim 7, wherein the seat base further includes a seat anchor coupled to an upper region of the seat-base foundation and the juvenile seat is formed to include a groove aligned with the seat anchor in the upright orientation so that the juvenile seat interlocks with the seat anchor in the forward-facing orientation.

14. A child restraint comprising
a seat base configured to rest on a vehicle seat,
a juvenile seat coupled to the seat base for rotation relative to the seat base about a pivot axis between a rearward-facing orientation, a forward-facing orientation, and a sideways-facing orientation, and
a seat-orientation controller including a rotating deck coupled to the seat base for rotation with the juvenile seat about the pivot axis, a track including a first rail coupled to the rotating deck for rotation therewith and a second rail coupled to the juvenile seat to allow translation of the juvenile seat relative to the seat base along a sliding plane from a first position overlying the pivot axis and a second position at least partially offset from the pivot axis, and a rotation lock movable from a locked configuration blocking rotation of the juvenile seat about the pivot axis and an unlocked configuration freeing rotation of the juvenile seat about the pivot axis, the rotation lock including a release handle coupled to the juvenile seat and configured to be actuated by a user to change the rotation lock from the locked configuration to the unlocked configuration, a latch configured to engage the seat base in the locked configuration to block rotation of the juvenile seat relative to the seat base and located on a first side of the sliding plane, and an actuator coupled to the release handle and configured to release the latch from the seat base in the unlocked configuration, the actuator located on a second side of the sliding plane opposite the first side and configured to translate with the juvenile seat away from the latch.

15. The child restraint of claim 14, wherein the actuator includes a cable coupled to the release handle for movement with the release handle, a cam block coupled to the cable and configured to be moved by the cable, and an actuator post coupled to the cam block and configured to engage with the latch to move the latch from a locked position engaged with the seat base to an unlocked position separated from the seat base to free the juvenile seat for rotation about the pivot axis.

16. The child restraint of claim 15, wherein the cam block includes an angled slot and the actuator post includes a pin received in the slot to cause movement of the actuator post in a first direction toward the latch in response to movement of the cam block in a second direction different than the first direction.

17. The child restraint of claim 16, wherein the first direction includes translation in the first direction and the second direction includes translation in the second direction transverse to the first direction.

18. The child restraint of claim 14, wherein a portion of the actuator extends into an opening formed in the rotating deck when the release handle is actuated to block the juvenile seat from translating relative to the seat base.

19. The child restraint of claim 14, further including a lockout system including a stop coupled to the seat base, a cam coupled to the juvenile seat, and a circumferential-motion blocker having a first travel path about the pivot axis and offset from the stop when the juvenile seat is in the first position and a second travel path about the first axis and aligned with the stop when the juvenile seat is in the second position so that the circumferential motion blocker engages the stop in the section position to block rotation of the juvenile seat about the pivot axis.

20. The child restraint of claim 19, wherein the circumferential-motion blocker includes a blocker body movable between the first travel path and the second travel path, a body actuator coupled to the locker body and configured to engage the stop, and a bias member configured to urge the blocker body toward the second travel path, and wherein the blocker body is formed to include an angled slot and the body actuator is received in the slot so that movement of the body actuator in a first direction causes movement of the blocker body in a second direction different than the first direction as the blocker actuator travels through the slot.
